(19) United States
(12) Patent Application Publication
(10) Pub. No.: US 2026/0316626 A1
(43) Pub. Date: Oct. 15, 2026

(54) VEHICLE

(71) Applicant: SUBARU CORPORATION, Tokyo (JP)

(72) Inventor: Kenta UWAI, Tokyo (JP)

(21) Appl. No.: 19/466,874

(22) Filed: Feb. 2, 2026

(30) Foreign Application Priority Data
Mar. 4, 2025 (JP) 2025-033738

(51) Int. Cl. B60L 58/15; B60L 58/27

(52) U.S. Cl. CPC B60L 58/15; B60L 58/27

(57) ABSTRACT

A vehicle includes: a first relay between a battery and a charging port to switch their connection; a heater in parallel with the battery on the charging port side of the first relay to heat the battery using power from the charging port; a second relay to switch the foregoing connection while bypassing the first relay; a diode in series with the second relay to restrict power flow from the charging port to the battery; and a control device including a processor(s) and a memory(ies). The processor(s) is configured to: transmit a command value of power from a power supply device; when the battery is in a first state, turn on the second relay and transmit a first command to cause the device to output a first power; and when in a second state, turn off the second relay, turn on the first relay, and output higher power.

### CROSS-REFERENCE TO RELATED APPLICATIONS

The present application claims priority from Japanese Patent Application No. 2025-033738 filed on Mar. 4, 2025, the entire contents of which are hereby incorporated by reference.

### BACKGROUND

The disclosure relates to a vehicle.

There have been charging systems available for charging a battery installed in a vehicle with power supplied from a charging station. For example, Japanese Unexamined Patent Application Publication (JP-A) No. 2021-13241 discloses a charging system capable of charging a battery installed in an electric vehicle with power supplied from a charging station.

### SUMMARY

An aspect of the disclosure provides a vehicle including a first relay, a heater, a second relay, a diode, and a control device. The first relay is provided between a battery and a charging port, and is configured to switch on or off an electrical connection between the battery and the charging port. The heater is provided in parallel with the battery on the charging port side of the first relay, and is configured to heat the battery at least with power supplied from the charging port. The second relay is configured to switch on or off the electrical connection between the battery and the charging port while bypassing the first relay and. The diode is provided in series with the second relay, and is configured to restrict flow of power from the charging port to the battery while bypassing the first relay. The control device is configured to control the first relay and the second relay. The control device includes one or more processors, and one or more memories coupled to the one or more processors. The one or more processors are configured to: transmit to a power supply device a command value of power to be received from the power supply device; when a state of the battery is a first state, switch on the second relay, and transmit a first command value to the power supply device to cause the power supply device to output a first power; and when the state of the battery is a second state, switch off the second relay, switch on the first relay, and transmit a second command value to the power supply device to cause the power supply device to output a second power greater than the first power.

### BRIEF DESCRIPTION OF THE DRAWINGS

FIG. 1 is a schematic diagram illustrating an example of the configuration of a charging system according to an embodiment of the disclosure;

FIG. 2 is a block diagram illustrating an example of the configuration of a control device according to the embodiment;

FIG. 3 is a block diagram illustrating an example of the functional configuration of the control device according to the embodiment;

FIG. 4 is a graph illustrating the states of each relay, a battery, a heater, and a power supply device in the control processing performed by a controller according to the embodiment;

FIG. 5 is a schematic diagram illustrating the state of each relay at time t2 in a precharge control process according to the embodiment;

FIG. 6 is a schematic diagram illustrating the state of each relay at time t4 in a temperature-increasing control process according to the embodiment; and

FIG. 7 is a schematic diagram illustrating the state of each relay at time t6 in a charging control process according to the embodiment.

### DETAILED DESCRIPTION

I maximum value of the power that a battery can receive has a characteristic of varying depending on its state of charge (SOC) and temperature. Hereinafter, the maximum value of the power that the battery can receive is simply referred to “s "receivable po”er". Therefore, for example, when a vehicle is charged at a charging station located in a cold region, the receivable power of the battery is often reduced, resulting in a problem that the charging time of the battery becomes longer.

Accordingly, it is desirable to shorten the charging time of the battery.

Hereinafter, an embodiment of the disclosure will be described in detail with reference to the accompanying drawings. The specific dimensions, materials, numerical values, and the like discussed in this embodiment are merely examples provided to facilitate understanding of the disclosure and are not intended to limit the disclosure, unless otherwise specified. Note that, in the present specification and drawings, elements having substantially the same functions and configurations are denoted by the same reference numerals, and redundant explanations thereof are omitted. Furthermore, elements not directly related to the disclosure are omitted from the drawings.

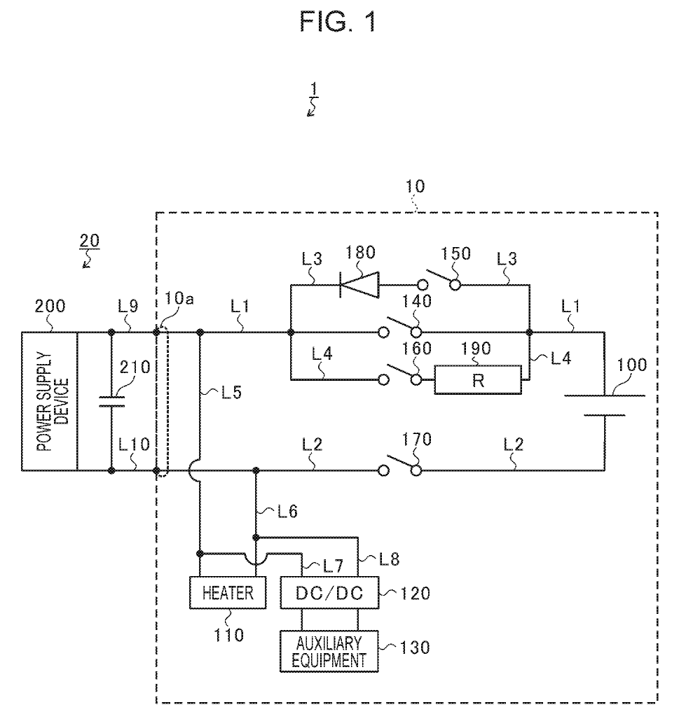

FIG. 1 is a schematic diagram illustrating an example of the configuration of a charging system 1 according to the present embodiment. The charging system 1 according to the present embodiment includes a vehicle 10 and a charging station 20. The vehicle 10 is a vehicle that uses electricity as an energy source and travels by an electric motor. The vehicle 10 according to the present embodiment is an electric vehicle equipped with a motor generator, which is an electric motor, as a drive source. However, the vehicle 10 is not limited to the above, and may be a hybrid vehicle equipped with an engine and a motor generator as a drive source.

The vehicle 10 includes a charging port 10a, a battery 100, a heater 110, a direct current-to-direct current (DC/DC) converter 120, and auxiliary equipment 130.

The charging port 10a is provided, for example, at the inlet of the vehicle 10. The inlet is provided, for example, on a lateral side of the body of the vehicle 10. The charging port 10a is exposed outside the vehicle 10 by opening the inlet door and removing a predetermined cover. While exposed to the outside, the charging port 10a can be mechanically and electrically coupled to a charging connector of a power supply device 200 provided at the charging station 20.

The battery 100 is a rechargeable secondary battery, such as a lithium-ion battery. The battery 100 supplies power to, for example, the motor generator, which is a drive source of the vehicle 10.

The heater 110 is a heating device that heats at least the battery 100. The heater 110 generates heat using power supplied from the battery 100 or from the power supply device 200. The heater 110 is provided so as to be capable of exchanging heat with the battery 100 via a heat transfer mechanism (not illustrated). Additionally, the heater 110 is provided in parallel with the battery 100 on the charging port 10a side of a first relay 140 and a fourth relay 170, which will be described later. The battery 100 is heated by the heat generated from the heater 110.

The DC/DC converter 120 converts the input power by changing the voltage and outputs it. In one example, the DC/DC converter 120 steps down the power supplied from the battery 100 and outputs it to the auxiliary equipment 130. The voltage of the battery 100 is, for example, 400 V. The DC/DC converter 120 steps down the 400 V of voltage input from the battery 100 to, for example, 12 V, and outputs it to the auxiliary equipment 130. Note that the DC/DC converter 120 may also step up the power input from the battery 100 and output it.

The auxiliary equipment 130 is a device that operates by power output from the DC/DC converter 120 and operates at a low voltage such as 12 V. Examples of the auxiliary equipment 130 include a car navigation system, an audio system, wipers, and headlamps.

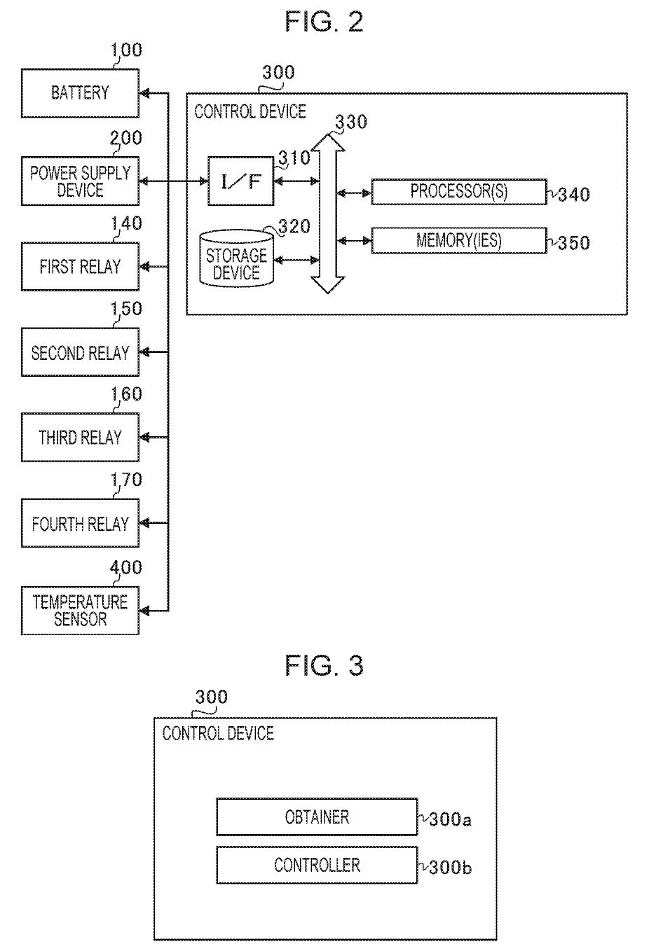

The vehicle 10 further includes the first relay 140, a second relay 150, a third relay 160, the fourth relay 170, a diode 180, a resistor 190, a control device 300 (see FIG. 2), and a temperature sensor 400 (see FIG. 2).

One of two terminals of the first relay 140 is electrically coupled to the positive terminal of the charging port 10a via a first power line L1. The other terminal of the first relay 140 is electrically coupled to the positive terminal of the battery 100 via the first power line L1. In this manner, the first relay 140 is provided between the battery 100 and the charging port 10a on the positive side of the battery 100, and switches the electrical connection between the battery 100 and the charging port 10a on or off.

One of two terminals of the fourth relay 170 is electrically coupled to the negative terminal of the charging port 10a via a second power line L2. The other terminal of the fourth relay 170 is electrically coupled to the negative terminal of the battery 100 via the second power line L2. In this manner, the fourth relay 170 is provided between the battery 100 and the charging port 10a on the negative side of the battery 100, and switches the electrical connection between the battery 100 and the charging port 10a on or off.

When a charging connector (not illustrated) of the charging station 20, which will be described later, is inserted into the charging port 10a, the positive terminal of the charging port 10a is electrically coupled to the positive terminal of the power supply device 200 via a ninth power line L9. When the charging connector (not illustrated) of the charging station 20, which will be described later, is inserted into the charging port 10a, the negative terminal of the charging port 10a is electrically coupled to the negative terminal of the power supply device 200 via a tenth power line L10. When the first relay 140 or the third relay 160 is in the ON state, the battery 100 and the power supply device 200 are electrically coupled to enable the transfer of power between the battery 100 and the power supply device 200.

One of two terminals of the second relay 150 is electrically coupled to the positive terminal of the charging port 10a via a third power line L3 and the first power line L1. The other terminal of the second relay 150 is electrically coupled to the positive terminal of the battery 100 via the third power line L3 and the first power line L1. The second relay 150 is provided in parallel with the first relay 140 and, via the third power line L3, bypasses the first relay 140. Accordingly, one terminal of the second relay 150 is electrically coupled to a position on the charging port 10a side relative to the first relay 140, or the other terminal is electrically coupled to a position on the battery 100 side relative to the first relay 140. In this manner, the second relay 150 switches the electrical connection between the battery 100 and the charging port 10a on or off on the positive side of the battery 100.

Additionally, the diode 180 is provided in parallel with the first relay 140 and in series with the second relay 150. The diode 180 is disposed between the second relay 150 and the charging port 10a while bypassing the first relay 140 via the third power line L3 and the first power line L1. In other words, the diode 180 is disposed on the charging port 10a side relative to the second relay 150. The cathode terminal of the diode 180 is electrically coupled to the positive terminal of the charging port 10a via the third power line L3 and the first power line L1. Additionally, the anode terminal of the diode 180 is electrically coupled to one terminal of the second relay 150 via the third power line L3. The diode 180 allows the flow of power from the anode terminal side to the cathode terminal side and restricts the flow of power from the cathode terminal side to the anode terminal side. When the first relay 140 and the third relay 160 are in the OFF state and the second relay 150 and the fourth relay 170 are in the ON state, the diode 180 allows the flow of power from the battery 100 to the charging port 10a and restricts the flow of power from the charging port 10a to the battery 100. Note that, although an example has been described here in which the diode 180 is disposed between the second relay 150 and the charging port 10a, the diode 180 may instead be disposed between the second relay 150 and the battery 100.

In this manner, the second relay 150 and the diode 180 are provided in parallel with the first relay 140.

One of two terminals of the third relay 160 is electrically coupled to the positive terminal of the charging port 10a via a fourth power line L4 and the first power line L1. Additionally, the other terminal of the third relay 160 is electrically coupled to the positive terminal of the battery 100 via the fourth power line L4 and the first power line L1. The third relay 160 is provided in parallel with the first relay 140, and bypasses the first relay 140 via the fourth power line L4. Accordingly, one terminal of the third relay 160 is electrically coupled to a position on the charging port 10a side relative to the first relay 140, while the other terminal is electrically coupled to a position on the battery 100 side relative to the first relay 140. In this manner, the third relay 160 switches the electrical connection between the battery 100 and the charging port 10a on or off on the positive side of the battery 100. Note that the third relay 160 is a precharge relay for performing a precharge to preliminarily charge a capacitor 210 in the power supply device 200, which will be described later, before turning on the power of the power supply device 200.

Additionally, the resistor 190 is provided in parallel with the first relay 140 via the fourth power line L4, and in series with the third relay 160. The resistor 190 is disposed between the third relay 160 and the battery 100 while bypassing the first relay 140 via the fourth power line L4 and the first power line L1. In other words, the resistor 190 is disposed on the battery 100 side relative to the third relay 160. When the first relay 140 and the second relay 150 are in the OFF state and the third relay 160 and the fourth relay 170 are in the ON state, the resistor 190 restricts the flow of current from the battery 100 to the power supply device 200.

In this manner, the third relay 160 and the resistor 190 are provided in parallel with the first relay 140.

The positive terminal of the heater 110 is electrically coupled to the positive terminal of the charging port 10a via a fifth power line L5 and the first power line L1. Additionally, when the first relay 140, the second relay 150, and the third relay 160 are in the ON state, the positive terminal of the heater 110 is electrically coupled to the positive terminal of the battery 100 via the fifth power line L5 and the first power line L1. The negative terminal of the heater 110 is electrically coupled to the negative terminal of the charging port 10a via a sixth power line L6 and the second power line L2. Additionally, when the fourth relay 170 is in the ON state, the negative terminal of the heater 110 is electrically coupled to the negative terminal of the battery 100 via the sixth power line L6 and the second power line L2.

The positive terminal of the auxiliary equipment 130 is electrically coupled to the positive terminal of the charging port 10a via the DC/DC converter 120, a seventh power line L7, and the first power line L1. Additionally, when the first relay 140, the second relay 150, and the third relay 160 are in the ON state, the positive terminal of the auxiliary equipment 130 is electrically coupled to the positive terminal of the battery 100 via the DC/DC converter 120, the seventh power line L7, and the first power line L1. The negative terminal of the auxiliary equipment 130 is electrically coupled to the negative terminal of the charging port 10a via the DC/DC converter 120, an eighth power line L8, and the second power line L2. Additionally, when the fourth relay 170 is in the ON state, the negative terminal of the auxiliary equipment 130 is electrically coupled to the negative terminal of the battery 100 via the DC/DC converter 120, the eighth power line L8, and the second power line L2.

FIG. 2 is a block diagram illustrating an example of the configuration of the control device 300 according to the present embodiment. The control device 300 controls the vehicle 10. In the present embodiment, the control device 300 mainly controls the first relay 140, the second relay 150, the third relay 160, and the fourth relay 170.

As illustrated in FIG. 2, the control device 300 includes an interface (I/F) 310, a storage device 320, a system bus 330, one or more processors 340, and one or more memories 350.

The I/F 310 is an interface for performing communication with the battery 100, the power supply device 200, the first relay 140, the second relay 150, the third relay 160, the fourth relay 170, and the temperature sensor 400. Note that the I/F 310 is electrically coupled to the battery 100, the power supply device 200, the first relay 140, the second relay 150, the third relay 160, the fourth relay 170, and the temperature sensor 400 via signal lines (not illustrated) that transfer information as electric signals.

The temperature sensor 400 is provided in the battery 100. The temperature sensor 400 measures the temperature of the battery 100 and transmits information indicating the measured temperature of the battery 100 to the control device 300.

The storage device 320 is configured with a random-access memory (RAM), flash memory, hard-disk drive (HDD), and the like, and holds various information necessary for the processing performed by the processor(s) 340 discussed below. The system bus 330 is a transmission line that electrically couples the I/F 310, the storage device 320, the processor(s) 340, and the memory(ies) 350, and transmits data among these devices.

The processor(s) 340 includes, for example, a central processing unit (CPU). The memory(ies) 350 includes, for example, a read-only memory (ROM) and RAM. The ROM is a storage element that stores programs and operational parameters for use by the CPU. The RAM is a storage element that temporarily stores data such as variables and parameters used for processing executed by the CPU.

FIG. 3 is a block diagram illustrating an example of the functional configuration of the control device 300 according to the present embodiment. For example, as illustrated in FIG. 3, the control device 300 includes an obtainer 300a and a controller 300b.

The processor(s) 340 cooperates with programs included in the memory(ies) 350 and executes the programs included in the memory(ies) 350, thereby implementing various processes including later-described processes performed by the obtainer 300a and the controller 300b.

The obtainer 300a obtains information on the SOC from the battery 100. The obtainer 300a also obtains information indicating the temperature of the battery 100 from the temperature sensor 400.

Based on the information obtained by the obtainer 300a, the controller 300b controls the first relay 140, the second relay 150, the third relay 160, and the fourth relay 170. The details of the control processing performed by the controller 300b will be described later.

Referring back to FIG. 1, the charging station 20 is a power supply facility for supplying power to the vehicle 10. In FIG. 1, the state is illustrated in which the vehicle 10 is parked within the premises where the charging station 20 is installed, with a charging connector (not illustrated) provided on the charging station 20 inserted into the charging port 10a of the vehicle 10. The charging station 20 includes the power supply device 200 and the capacitor 210.

The power supply device 200 is, for example, electric vehicle supply equipment (EVSE). The power supply device 200 includes a charging cable and a charging connector (both are not illustrated). By inserting the charging connector into the charging port 10a of the vehicle 10, the power supply device 200 is mechanically and electrically coupled to the vehicle 10. Note that the ninth power line L9 and the tenth power line L10 are provided inside the charging cable and the charging connector (both are not illustrated).

With the charging connector (not illustrated) inserted into the charging port 10a of the vehicle 10, the positive terminal of the power supply device 200 is electrically coupled to the positive terminal of the charging port 10a via the ninth power line L9.

With the charging connector (not illustrated) inserted into the charging port 10a of the vehicle 10, the negative terminal of the power supply device 200 is electrically coupled to the negative terminal of the charging port 10a via the tenth power line L10.

The capacitor 210 is an electronic component that stores or releases electric charge. The capacitor 210 is provided inside the charging station 20. The capacitor 210 is provided in parallel with the power supply device 200, and receives power supplied from the battery 100 of the vehicle 10, thereby storing the electric charge.

Hereinafter, the details of the control processing performed by the controller 300b will be described. In the present embodiment, the controller 300b, when initiating the charging of the battery 100, executes the processing in the following order: a precharge control process, a temperature-increasing control process, and a charging control process.

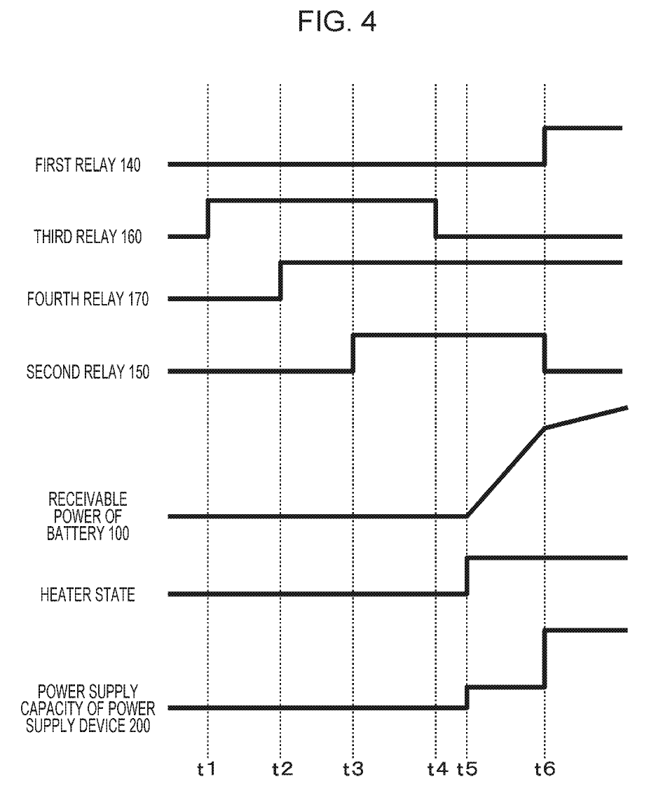

FIG. 4 is a graph illustrating the states of each relay, the battery 100, the heater 110, and the power supply device 200 in the control processing performed by the controller 300b according to the present embodiment. As illustrated in FIG. 4, at the start of the charging of the battery 100, the first relay 140, the second relay 150, the third relay 160, the fourth relay 170, and the heater 110 are in the OFF state. Note that, at this point, the power supply device 200 does not output power.

At time t1, the controller 300b starts the precharge control process, and controls the third relay 160 to transition from the OFF state to the ON state. At time t2, which is after time t1, the controller 300b controls the fourth relay 170 to transition from the OFF state to the ON state.

When the third relay 160 and the fourth relay 170 enter the ON state, the precharging of the capacitor 210 in the power supply device 200 is initiated. Here, as illustrated in FIG. 4, the timing of switching on the third relay 160 is different from the timing of switching on the fourth relay 170. This is to determine whether each relay is stuck when each relay is controlled to transition to the ON state.

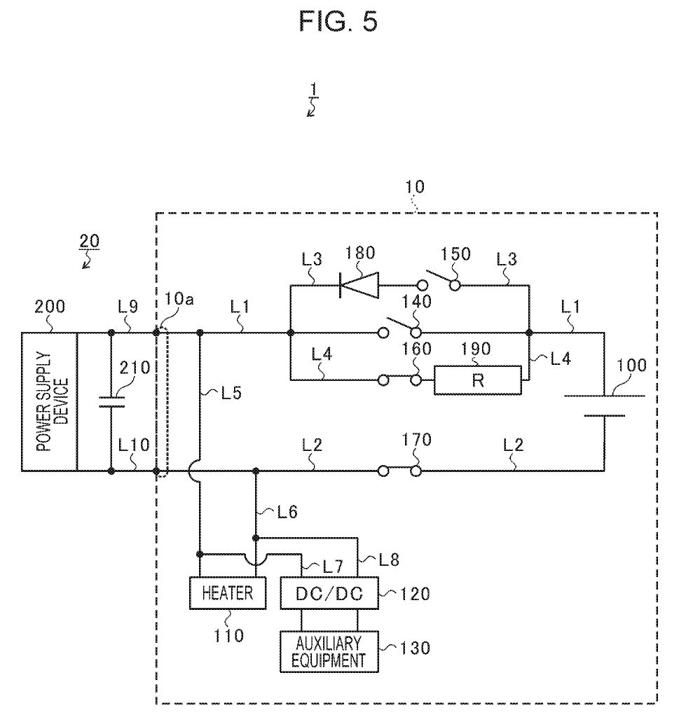

FIG. 5 is a schematic diagram illustrating the state of each relay at time t2 in the precharge control process according to the present embodiment. As illustrated in FIG. 5, in the precharge control process, the first relay 140 and the second relay 150 are switched off, and the third relay 160 and the fourth relay 170 are switched on. Additionally, at this point, the power supply device 200 has not output power yet.

Accordingly, the battery 100 and the capacitor 210 in the power supply device 200 are electrically coupled to each other via the first power line L1, the second power line L2, the fourth power line L4, the ninth power line L9, and the tenth power line L10. Then, the capacitor 210 receives the power supplied from the battery 100, thereby storing the electric charge. Here, since the fourth power line L4 is provided with the resistor 190, the flow of current from the battery 100 to the capacitor 210 can be restricted during the precharge control process. Here, it becomes ready for the power supply device 200 to output power.

Referring back to FIG. 4, at time t3, which is after time t2, the controller 300b initiates the temperature-increasing control process, and controls the second relay 150 to transition from the OFF state to the ON state. At this time, the controller 300b transmits to the power supply device 200 a command value of power to be received from the power supply device 200 via a signal line (not illustrated). This command value is a request value corresponding to the power consumption of the battery 100. In one example, the power consumption of the battery 100 is, for example, 10 kW. As power to be received from the power supply device 200, the controller 300b transmits a command value corresponding to 10 kW to the power supply device 200.

Additionally, at time t4, which is after a predetermined time necessary for the precharge has elapsed since time t2, which is the precharge start time, the controller 300b terminates the precharge control process, and controls the third relay 160 to transition from the ON state to the OFF state. The time period from time t2 to time t4 is a predetermined time necessary for the precharge. Here, the electric charge of the precharged capacitor 210 is released immediately after the precharge control process is terminated. Thus, while the electric charge stored in the capacitor 210 still remains, the temperature-increasing control process is executed. Therefore, the precharge control process and the temperature-increasing control process partially overlap.

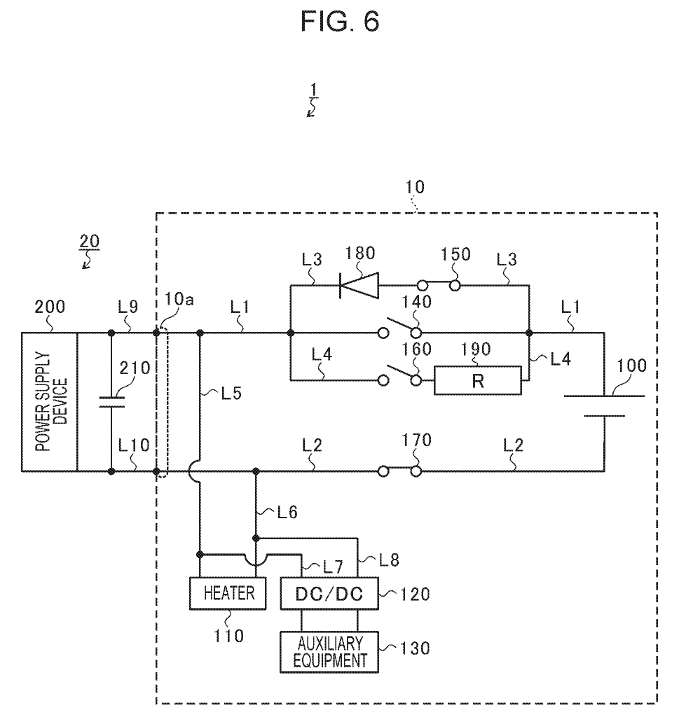

FIG. 6 is a schematic diagram illustrating the state of each relay at time t4 in the temperature-increasing control process according to the present embodiment. As illustrated in FIG. 6, in the temperature-increasing control process, the first relay 140 and the third relay 160 are switched off, and the second relay 150 and the fourth relay 170 are switched on.

Accordingly, the power supply device 200 and the heater 110 are electrically coupled to each other via the first power line L1, the second power line L2, the fifth power line L5, the sixth power line L6, the ninth power line L9, and the tenth power line L10. The heater 110 then generates heat by receiving the power supplied from the power supply device 200, and thus heats the battery 100.

By the way, the receivable power of the battery 100 has a characteristic of varying depending on its SOC and temperature. Therefore, for example, when the vehicle 10 is charged at the charging station 20 located in a cold region, the receivable power of the battery 100 is restricted. Furthermore, if the battery 100 is charged with power exceeding the receivable power of the battery 100, the battery 100 may be damaged.

The battery 100 can also be heated by the heater 110 to raise its temperature and thereby increase the receivable power. However, if power is supplied from the battery 100 to the heater 110 in order to drive the heater 110, the power stored in the battery 100 is consumed, which, as a result, prolongs the charging time of the battery 100.

In addition, if power is supplied from the power supply device 200 to drive the heater 110, a portion of the power supplied from the power supply device 200 may be supplied to the battery 100, and if this portion of power exceeds the receivable power, the battery 100 may be damaged. Therefore, it is necessary for the power supplied from the power supply device 200 to be less than the receivable power, and, if the heater 110 is driven with this power, the heating time of the battery 100 by the heater 110 becomes longer, which, as a result, prolongs the charging time of the battery 100.

Therefore, in the present embodiment, in order to increase the receivable power of the battery 100, when heating the battery 100 with the heater 110, while it is allowed to supply power from the power supply device 200 to the heater 110, there is provided a disconnecting mechanism configured to be capable of disconnecting the power supply from the power supply device 200 to the battery 100. In the present embodiment, the disconnecting mechanism includes the second relay 150 and the diode 180.

The diode 180 allows the flow of power from the battery 100 to the charging port 10a and restricts the flow of power from the charging port 10a to the battery 100. Thus, even if the power supplied from the power supply device 200 is greater than the receivable power of the battery 100, the diode 180 is able to restrict the supply of this power to the battery 100.

Referring back to FIG. 4, at time t5, which is after time t4, the controller 300b starts supplying power from the power supply device 200, and, with this power, the heater 110 starts driving and generates heat. This in turn heats the battery 100, thereby raising the temperature of the battery 100 as well as the receivable power of the battery 100.

When the vehicle 10 is charged at the charging station 20 located in a cold region, the temperature of the battery 100 is, for example, -20°C. In FIG. 4, the temperature of the battery 100 at time t5 is -20°C, and the receivable power of the battery 100 at this time is about 0 kW. In other words, the state of the battery 100 at time t5 is a state in which the receivable power of the battery 100 is less than a predetermined power (first state).

Additionally, at time t5, in response to a command value corresponding to 10 kW transmitted from the controller 300b, the power supply device 200 supplies 10 kW of power (first power) corresponding to the power consumption of the heater 110 to the vehicle 10. The heater 110 receives the 10 kW of power supplied from the power supply device 200, starts driving, and transitions from a stopped state in which no heat is generated to a driving state in which heat is generated.

Here, if a portion of the 10 kW of power supplied from the power supply device 200 is supplied to the battery 100, this portion of power will exceed about 0 kW, which is the receivable power of the battery 100, and the battery 100 may be damaged.

On the other hand, in order to avoid such damage, if the power supplied from the power supply device 200 is reduced to 1 kW, for example, the power supplied to the heater 110 will be 1 kW, and the heating time of the battery 100 by the heater 110 becomes longer, which, as a result, prolongs the charging time of the battery 100.

In contrast, according to the present embodiment, since the diode 180 is provided, even if the power supplied from the power supply device 200 is greater than the receivable power of the battery 100, it is possible to restrict the supply of this power to the battery 100. In one example, even if the power supplied from the power supply device 200 is 10 kW, for example, the diode 180 can restrict a portion of that power from being supplied to the battery 100. Also, since 10 kW of power can be supplied to the heater 110, the heating time of the battery 100 by the heater 110 becomes shorter, which, as a result, shortens the charging time of the battery 100.

Additionally, the diode 180 allows the flow of power from the battery 100 to the charging port 10a. Thus, in the temperature-increasing control process, power for driving the auxiliary equipment 130 can be supplied from the battery 100 to the auxiliary equipment 130. Accordingly, even in the temperature-increasing control process, occupants in the vehicle 10 can use the auxiliary equipment 130, such as the car navigation system and the audio system of the vehicle 10.

At time t6, which is after time t5, the receivable power of the battery 100 becomes greater than or equal to the predetermined power. The controller 300b derives the receivable power of the battery 100 based on the SOC and temperature of the battery 100. Additionally, the controller 300b determines whether the receivable power of the battery 100 has become greater than or equal to the predetermined power. A state in which the receivable power of the battery 100 has become greater than or equal to the predetermined power is, for example, a state in which the temperature of the battery 100 falls within an appropriate temperature range. The appropriate temperature range is, for example, 20°C to 25°C. In other words, at time t6, the state of the battery 100 is a state in which the temperature of the battery 100 has fallen within the appropriate temperature range, and the receivable power of the battery 100 is greater than or equal to the predetermined power (second state). Here, the predetermined power is, for example, 40 kW. Note that the predetermined power is not limited to the above, and may be, for example, a power greater than or equal to the power consumption of the heater 110.

When it is determined that the receivable power has become greater than or equal to the predetermined power, the controller 300b starts the charging control process, controls the first relay 140 to transition from the OFF state to the ON state, and, since it is no longer necessary to restrict power from being supplied to the battery 100, controls the second relay 150 to transition from the ON state to the OFF state. On the other hand, while it is determined that the receivable power is less than the predetermined power, the controller 300b does not start the charging control process, and maintains the first relay 140 in the OFF state and the second relay 150 in the ON state.

Additionally, when it is determined that the receivable power has become greater than or equal to the predetermined power, the controller 300b transmits to the power supply device 200 a command value (second command value) of power to be received from the power supply device 200. This command value is, for example, a request value obtained by multiplying, by a predetermined coefficient less than 1 (for example, 0.8), a power value obtained by adding the power consumption of the heater 110 to the receivable power of the battery 100, in order to provide a margin. In one example, the receivable power of the battery 100 at time t6 is, for example, 40 kW, and the power consumption of the heater 110 is 10 kW. Thus, the controller 300b calculates the request value as (40 kW + 10 kW) × 0.8 = 40 kW. The controller 300b then transmits the request value as a command value (second command value) to the power supply device 200. Accordingly, the power supply device 200 supplies 40 kW of power (second power) in accordance with the command value to the vehicle 10.

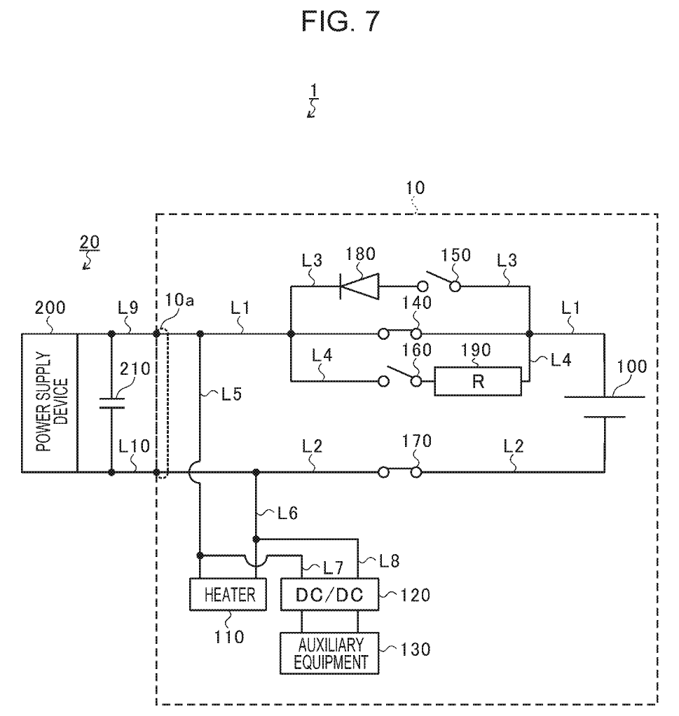

FIG. 7 is a schematic diagram illustrating the state of each relay at time t6 in the charging control process according to the present embodiment. As illustrated in FIG. 7, in the charging control process, the second relay 150 and the third relay 160 are switched off, and the first relay 140 and the fourth relay 170 are switched on.

Accordingly, the power supply device 200 and the battery 100 are electrically coupled to each other via the first power line L1, the second power line L2, the ninth power line L9, and the tenth power line L10. The battery 100 is then charged by receiving the power supplied from the power supply device 200.

Note that, in the charging control process, the power supply device 200 and the heater 110 are electrically coupled to each other via the first power line L1, the second power line L2, the fifth power line L5, the sixth power line L6, the ninth power line L9, and the tenth power line L10. Thus, in the charging control process, the heater 110 also receives the power supplied from the power supply device 200 and generates heat.

In the charging control process, the receivable power (for example, 40 kW) of the battery 100 at time t6 is sufficiently greater than the receivable power (about 0 kW) of the battery 100 at time t5. Additionally, as described above, the command value has a margin and is a value obtained by multiplying, by a predetermined coefficient less than 1 (for example, 0.8), a power value obtained by adding the power consumption of the heater 110 to the receivable power of the battery 100. Accordingly, even if, for example, the heater 110 malfunctions and the amount of power corresponding to the power consumption of the heater 110 is supplied to the battery 100, it is possible to restrict power exceeding the receivable power of the battery 100 from being supplied to the battery 100. As a result, the charging time of the battery 100 can be shortened while protecting the battery 100.

As described above, according to the present embodiment, the controller 300b switches on the second relay 150 when the battery 100 is in the first state, and transmits the first command value to the power supply device 200 to cause the power supply device 200 to output the first power. Also, when the battery 100 is in the second state, the controller 300b switches off the second relay 150 and switches on the first relay 140, and transmits the second command value to the power supply device 200 to cause the power supply device 200 to output the second power greater than the first power. Accordingly, the heating time of the battery 100 by the heater 110 can be shortened, and the charging time of the battery 100 can be shortened.

Furthermore, the first state of the battery 100 is a state in which the receivable power of the battery 100 is less than the predetermined power, and the second state is a state in which the receivable power of the battery 100 is greater than or equal to the predetermined power. Accordingly, in a state in which the receivable power of the battery 100 is less than the predetermined power, power is prevented from being supplied to the battery 100, thereby enabling the protection of the battery 100. Additionally, in a state in which the receivable power of the battery 100 is greater than or equal to the predetermined power, power can be supplied to the battery 100, thereby enabling the rapid charging of the battery 100.

Furthermore, the controller 300b transmits, as the first command value, a request value corresponding to the power consumption of the heater 110 to the power supply device 200. Accordingly, since 10 kW of power, which is the power consumption of the heater 110, can be supplied to the heater 110, the heating time of the battery 100 by the heater 110 can be shortened, which, as a result, shortens the charging time of the battery 100.

The controller 300b also transmits to the power supply device 200, as the second command value, a request value obtained by multiplying, by a predetermined coefficient less than 1, a power value obtained by adding the power consumption of the heater 110 to the receivable power of the battery 100. Accordingly, even if, for example, the heater 110 malfunctions and the amount of power corresponding to the power consumption of the heater 110 is supplied to the battery 100, it is possible to restrict power exceeding the receivable power of the battery 100 from being supplied to the battery 100. As a result, the charging time of the battery 100 can be shortened while protecting the battery 100.

When the state of the battery 100 is the first state, power is supplied from the battery 100 to the auxiliary equipment 130 via the second relay 150 and the diode 180. Accordingly, even in the temperature-increasing control process, occupants in the vehicle 10 can use the auxiliary equipment 130, such as the car navigation system and the audio system of the vehicle 10.

When the state of the battery 100 is the first state, the diode 180 restricts the flow of power, exceeding the receivable power of the battery 100, from the charging port 10a to the battery 100. Accordingly, in a state in which the receivable power of the battery 100 is low, when the temperature-increasing control process is executed, power exceeding the receivable power of the battery 100 is prevented from being supplied to the battery 100, and the battery 100 can be protected.

Although the preferred embodiment of the disclosure has been described above with reference to the accompanying drawings, it goes without saying that the disclosure is not limited to the embodiment. It will be apparent to those skilled in the art that various modifications or alterations can be conceived within the scope of the claims, and it is to be understood that such modifications or alterations also fall within the technical scope of the disclosure.

Accordingly, the charging time of the battery can be shortened.

The control device 300 illustrated in FIG. 2 can be implemented by circuitry including at least one semiconductor integrated circuit such as at least one processor (e.g., a central processing unit (CPU)), at least one application specific integrated circuit (ASIC), and/or at least one field programmable gate array (FPGA). At least one processor can be configured, by reading instructions from at least one machine readable tangible medium, to perform all or a part of functions of the control device 300. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the non-volatile memory may include a ROM and an NVRAM. The ASIC is an integrated circuit (IC) customized to perform, and the FPGA is an integrated circuit designed to be configured after manufacturing in order to perform, all or a part of the functions of the modules illustrated in FIG. 2.

1. A vehicle comprising:
a first relay provided between a battery and a charging port, and configured to switch on or off an electrical connection between the battery and the charging port;
a heater provided in parallel with the battery on a charging port side of the first relay, and configured to heat the battery at least with power supplied from the charging port;
a second relay configured to switch on or off the electrical connection between the battery and the charging port while bypassing the first relay;
a diode provided in series with the second relay, and configured to restrict flow of power from the charging port to the battery while bypassing the first relay; and
a control device configured to control the first relay and the second relay,
wherein the control device comprises:
one or more processors; and
one or more memories coupled to the one or more processors,
and
the one or more processors are configured to:
transmit to a power supply device a command value of power to be received from the power supply device;
when a state of the battery is a first state, switch on the second relay, and transmit a first command value to the power supply device to cause the power supply device to output a first power; and
when the state of the battery is a second state, switch off the second relay, switch on the first relay, and transmit a second command value to the power supply device to cause the power supply device to output a second power greater than the first power.

2. The vehicle according to claim 1, wherein:
the first state is a state in which a receivable power of the battery is less than a predetermined power; and
the second state is a state in which the receivable power of the battery is greater than or equal to the predetermined power.

3. The vehicle according to claim 2, wherein:
the one or more processors are configured to:
transmit, as the first command value, a request value corresponding to power consumption of the heater to the power supply device; and
transmit to the power supply device, as the second command value, a request value obtained by multiplying, by a predetermined coefficient less than 1, a power value obtained by adding the power consumption of the heater to the receivable power of the battery.

4. The vehicle according to claim 1, wherein:
the diode is configured to, when the state of the battery is the first state, restrict flow of power from the charging port to the battery, the flow exceeding the receivable power of the battery.

5. The vehicle according to claim 2, wherein:
the diode is configured to, when the state of the battery is the first state, restrict flow of power from the charging port to the battery, the flow exceeding the receivable power of the battery.

6. The vehicle according to claim 3, wherein:
the diode is configured to, when the state of the battery is the first state, restrict flow of power from the charging port to the battery, the flow exceeding the receivable power of the battery.
